(19) United States
(12) Patent Application Publication
(10) Pub. No.: US 2021/0200213 A1
(43) Pub. Date: Jul. 1, 2021

(54) Modular robotic vehicle

(71) Applicant: CARLA R GILLETT, Sacramento, CA (US)

(72) Inventor: CARLA R GILLETT, Sacramento, CA (US)

(73) Assignee: Carla R. Gilett, Sacramento, CA (US)

(21) Appl. No.: 16/873,674

(22) Filed: Dec. 18, 2019

Related U.S. Application Data
(63) Continuation-in-part of application No. 15/331,820, filed on Oct. 22, 2016, now Pat. No. 10,625,593.

(51) Int. Cl. G05D 1/00; G05D 1/02; G01S 17/931; G01S 13/931; G01S 15/931; B60R 25/01; B60R 25/23; B60Q 1/26

(52) U.S. Cl. CPC G05D 1/0088; G05D 1/0278; G05D 1/028; G01S 17/931; G01S 13/931; B60Q 2400/20; G05D 1/0246; B60R 25/01; B60R 25/23; B60Q 1/26; G05D 2201/0213; G01S 15/931

(57) ABSTRACT

A modular robotic vehicle (MRV) having a modular chassis configured for a vehicle utilizing two-wheel steering, four-wheel steering, six-wheel steering, eight-wheel steering controlled by a semiautonomous system or an autonomous driving system, either system is associated with operating modes which may include a two-wheel steering mode, an all-wheel steering mode, a traverse steering mode, a park mode, or an omni-directional mode utilized for steering sideways, driving diagonally or move crab like. Accordingly, during semiautonomous control a driver of the modular robotic vehicle may utilize smart I/O devices including a smartphone, tablet like devices, or a control panel to select a preferred driving mode. The driver may communicate navigation instructions via smart I/O devices to control steering, speed and placement of the MRV in respect to the operating mode. Accordingly, GPS and a wireless network provides navigation instructions during an autonomous operation involving driving, parking, docking or connecting to another MRV.

### CROSS REFERENCED TO RELATED APPLICATIONS

A notice of issuance for a continuation in part in reference to patent application Ser. No. 15/331,820, filing date: Oct. 22, 2016, titled: “Self-Balancing Robot System Comprising Robotic Omniwheel”, and to related applications: Ser. No. 12/655,569, filing date: Jan. 4, 2010 or U.S. Pat. No. 8,430,192 B2 titled: “Robotic Omniwheel Vehicle”; and to Ser. No. 13/872,054, filing date: Apr. 26, 2013 or U.S. Pat. No. 9,586,471 B2 titled: “Robotic Omniwheel”; and to Ser. No. 15/269,842, filing date: Sep. 19, 2016 or U.S. Pat. No. 9,902,253 B2 titled: “Yoke Module System for Powering a Motorized Wheel”.

### FIELD

The present disclosure relates to robotic vehicles utilizing a modular chassis especially capable of autonomous driving control provided by robotic drive wheels.

### BACKGROUND

Related art for compatibility the system design of the present invention provides a control platform, in addition to robotics, intelligent control also involves control of the field of occupational and meet the needs of autonomous multi-service robots for users, and for general applications. Autonomous controlled robots and robot vehicles are becoming more prevalent today and are used to perform tasks traditionally considered to work in a controlled environment indoors or outdoors. As the programming technology increases, so too does the demand for robotic vehicles that can navigate around complex environments.

Robotic devices vehicles associated autonomous drive control systems, wireless navigational systems, bi-wire systems and other related systems are being continuously developed for intelligent transportation to transport passengers and needed to improve logistics to transport payloads, however vehicle's claiming to robotic vehicle use a drivetrain providing differential drive, ideally what is essential for the advancement of robotic vehicle technology is developing robotic vehicles capable of traveling at zero-degrees and provide autonomous drive system programmed for synchronizing some or all drive wheels to turn simultaneously to steer a robotic vehicle in any direction, holonomic meaning like how a crab moves.

### SUMMARY

The present robotic vehicle offers a modular chassis configured with an array of robotic drive wheels accommodating different vehicle body types characterized as: a self-balancing vehicle, a tricycle, a minicar, a golf cart, a bumper car, a ride-on toy, a sedan, a truck, an ATV, RVs and multiple types of delivery trucks and vans, as one skilled in the art other vehicle body types can be realized, each capable to drive about like how a crab moves or holonomic-ally allowing the robotic vehicle to parallel park and perform unique driving stunts like coupling together. Respectively the present modular robotic vehicle comprises a control system utilizing various components for controlling steering, velocity and stability of the modular robotic vehicle such that a variety of operating modes are accomplish by means of two-four-six-eight robotic drive wheel steering and braking. The present modular robotic vehicle offers of an array of right and left robotic drive wheels capable of steering holonomic-ally in the following multiple fore and aft directions; for example; at 90-degrees driving sideways, at an approximate 45-degrees or 270-degrees form steering laterally, and omni-directionally driving in complete circles and performing other stunts.

### BRIEF DESCRIPTION OF THE DRAWINGS

FIG. 1A and FIG. 1B are side and front views of a robot MRV 100A comprising modular chassis 200A connectively coupled with body 218A in accordance with the present disclosure.

FIG. 2A is a front angular view of a modular chassis 200A with a covered body 218 in accordance with the present disclosure.

FIG. 2B is a see-through view of an assembled modular chassis 200A in accordance with the present disclosure.

FIG. 2C is a see-through view of the frame assemblies of the modular chassis 200A in accordance with the present disclosure.

FIG. 3A is a front view of the robotic drive wheel 300 comprising a hanger arm 304A assembled with flange fasteners in accordance with the present disclosure.

FIG. 3B is a front view of the robotic drive wheel 300 comprising a hanger arm 304 assembled on tubing brackets in accordance with the present disclosure.

FIG. 3C illustrating drive wheel array 301 assemblies in accordance with the present disclosure.

FIG. 4A and FIG. 4B are flowcharts of the modular robotic vehicle Control System 400 in accordance with the present disclosure.

FIG. 5 is an angular view of a wheelchair MRV 100B comprising modular chassis 200A connectively coupled with body 218B in accordance with the present disclosure.

FIG. 6 is an angular view of a tricycle MRV 100C configured with modular chassis 200B connectively coupled with body 218C in accordance with the present disclosure.

FIG. 7 is an angular view of a mini-car MRV 100D configured with modular chassis 200B connectively coupled with body 218D (with a hood) in accordance with the present disclosure.

FIG. 8 is an angular view of gyro-car MRV 100E configured modular chassis 200B connectively coupled with body 218E in accordance with the present disclosure.

FIG. 9 is an angular view of a sedan MRV 100F configured with modular chassis 2000 connectively coupled with a body 218F in accordance with the present disclosure.

FIG. 10 illustrates a minivan MRV 100G configured modular chassis 2000 connectively coupled with body 218G in accordance with the present disclosure.

FIG. 11 illustrates a truck MRV 100H configured with modular chassis 2000 connectively coupled with body 218H in accordance with the present disclosure.

FIG. 12 illustrates an ATV MRV 100I configured with modular chassis 2000 connectively coupled with body 218I in accordance with the present disclosure.

FIG. 13 illustrates a delivery van MRV 100J configured modular chassis 2100 connectively coupled with body 218J in accordance with the present disclosure.

FIG. 14 illustrates a delivery van MRV100K configured modular chassis 2200 connectively coupled with body 218K in accordance with the present disclosure.

FIG. 15 illustrates a semi-truck MRV 100L configured with chassis 2200 connectively coupled with body 218L in accordance with the present disclosure.

FIG. 16 illustrates a recreational vehicle (RV) MRV 100M configured with modular chassis 2000 connectively coupled with body 218M in accordance with the present disclosure.

FIG. 17 illustrates MRV 100N configured with modular chassis 2000 connectively coupled with body 218N and illustrates MRV 100NN configured with modular chassis 1900 connectively coupled with body 218NN in accordance with the present disclosure.

FIG. 18 illustrates MRV 100O configured with modular chassis 2300 connectively coupled with body 218O in accordance with the present disclosure.

FIG. 19 is a perspective view of a cab 1900 in accordance with the present disclosure.

FIG. 20 is an opened view of the MRV cab 2000 contents in accordance with the present disclosure.

FIG. 21 is a front view of assembled modular chassis 2100 in accordance with the present disclosure.

FIG. 22 is a front view of assembled modular chassis 2200 in accordance with the present disclosure.

FIG. 23 is a front view of assembled modular chassis 2300 in accordance with the present disclosure.

FIGS. 24-FIG. 31C are schematic diagrams of the various operating modes 2400-2900 in accordance with the present disclosure.

### DETAILED DESCRIPTION OF THE DRAWINGS

The present application offers different types of modular robotic vehicles 100 utilizing a modular chassis 200A—2300 and robotic drive wheels 300 henceforth as: “MRV”, “MRV 100”, “modular robotic vehicle 100” configured to be a manned or unmanned modular and utilized for personal use or utilized for commercial applications, service work accommodating various professions. Primarily the modular robotic vehicle MRV 100 is utilized by a driver 101 selecting to drive manually or be driven autonomously.

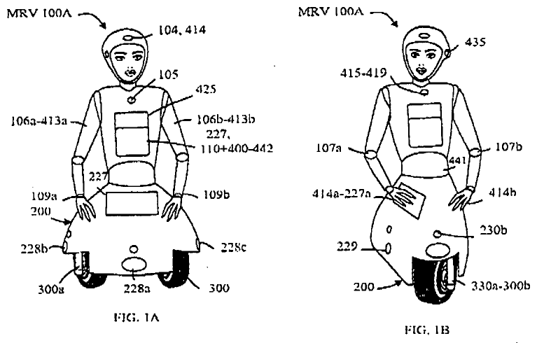

In greater detail FIG. 1A illustrates a front view of robot MRV 100A and FIG. 1B illustrates a side view of robot MRV 100A comprises modular chassis 200A said modular chassis 200A is shown connectively coupled with a right side couple with a right robotic drive 300a and a left side connectively coupled with a left robotic drive wheel 300b. Accordingly to those skilled in the art the chassis module and frame assemblies can be configured with side sections, corners, or a combination of corners and side sections; respectively one or more robotic drive wheels arranged on said side sections, said corners, or said combination of said corners and said side sections. As shown in the robot MRV 100A is configured with an augmented head 104 disposed on an upper portion, the augmented head comprising computer-generated interactive facial components, the head 104 being human like or animal like; or an augmented head with interactive LED lighting components being futuristic looking; a truck portion 105 configured with one or more robotic arms 106a, 106b; said one or more robotic arms configured with robotic hands, grippers 109a, 109b, suction devices, or other handling implements; a disjointed waist 107, said disjointed waist 107 disposed between said trunk portion 105 and a base portion 108 , said disjointed waist 107 configured to rotate said trunk portion 105 at an approximate angle degree opposed to said base portion 108, the trunk portion 105 configured with a control panel 425 and compartment 110 with hatch, the compartment 110 utilized for housing a control system 400 and various components 401-442 including head lamps 111 and turn signals 112 cameras 413 and sensor 414-419.

In various elements the frame assemblies include encasements for housing a Control System 400 and a battery(s), wherein the robot MRV 100A comprise subsystem providing various components 401-450. The control system 400 is associated with control processes utilizing a semiautonomous system 401 for manual driving or using an autonomous driving system 402, processors 403, associated with an assortment of cameras 414 and sensors which may include; LIDAR 415, Radar 416, an acoustic sensor 417, an ultrasonic sensor 418, a contact sensor 419, or other perimeter monitoring sensors providing sensor data 420 based on determining objects in an environment 421, a gyroscope 441 contained within a body 218B or an IMU provided to assist with balance of the humanoid MRV 100A and a virtual personal assistant 435 .

In various element the robot MRV 100A robotic drive wheels comprise a hanger arm is connectively coupled onto the frame by an arrangement of fasteners, nuts and bolts; a steering controller accordance with driver 101 or user 102 instructions and in accordance with the autonomous driving system 402 for separately controlling the rotational direction of a drive wheel and the velocity of the motor, the chassis and robotic drive wheel are detailed herein.

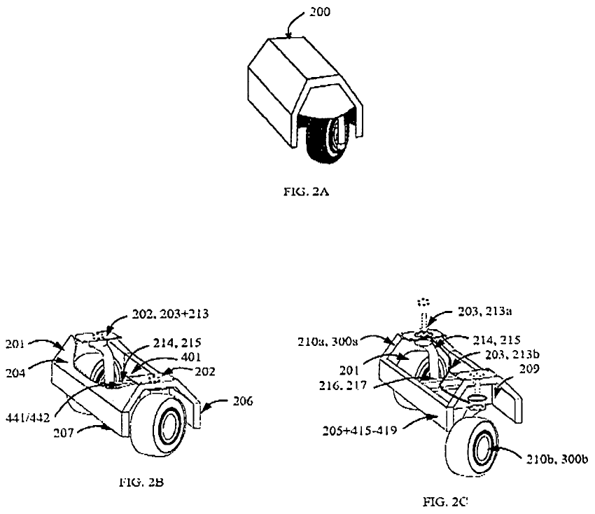

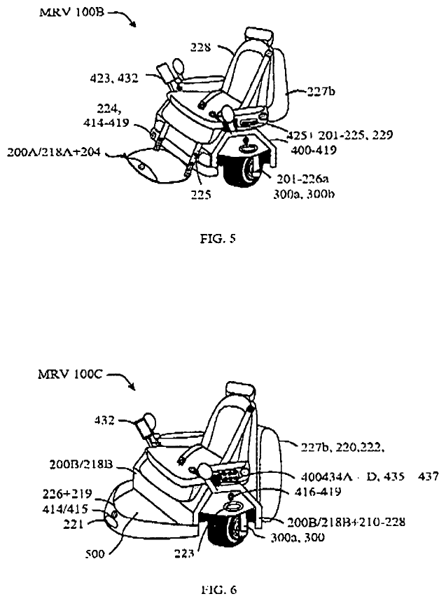

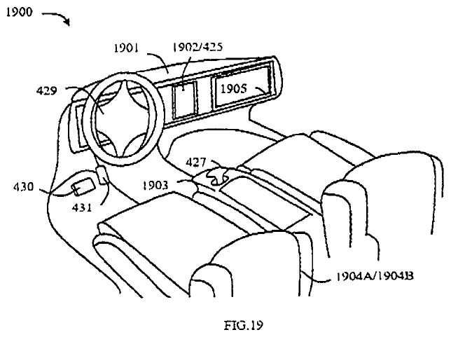

In greater detail FIG. 2 exemplifies a modular chassis 200; the modular chassis including frame assemblies configured with side sections, corners, or a combination of corners and side sections; one or more robotic drive wheels arranged on said modular chassis; the fully assembled modular chassis 200 comprising a set of robotic drive wheels 300a and 300b disposed on the sides of the modular chassis 200, respectively the modular chassis is utilized in the construction of a small vehicle utilizing one modular chassis 200A/200B detailed in FIGS. 5-8 or a large vehicle utilizing more than one modular chassis 200 as detailed in FIGS. 19-22.

Accordingly herein FIG. 2A, FIG. 2B and FIG. 2C provide perspective illustrations of the modular chassis frame 201, wherein the frame including; metal brackets 202 assembled with nut and bolts 203, as shown an upper portion 204, a front portion 204, an end portion 206, a lower portion 207, a centralized cavity 401, frame openings 209, a right side section 210a and a left side section 210b, an encasement 211a, 211b, a first housing 212, fasteners 213, an array of wiring 214 with electrical connectors 215a, 215b; as shown a right robotic drive wheel 300a is disposed on the right side section 210a as indicated by arrows and a left robotic drive wheel 300b is disposed on a left side section 210b as indicated by arrows; respectively a battery 216 and charger 217 is disposed within the centralized cavity 401, and a gyroscope 439 provided to assist with balance of the modular robotic vehicle 100, the gyroscope accelerometer 441 set at center mass (CM) and housed also within the centralized cavity 401, and may include an IMU 442 and array of sensors 415-419.

In various elements the modular chassis type 200A/200B, 1900-2200 is constructive to couple with a vehicle body 218, the vehicle body type varies as indicted by numbering: 218A-218O in FIGS. 1, 5-18, the body 218 accommodates at least one bumper 219 which is constructed of impact-resistant plastic, rubber, or another suitable material.

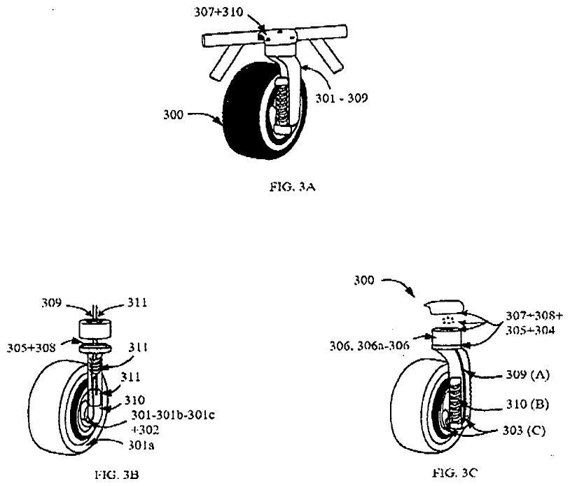

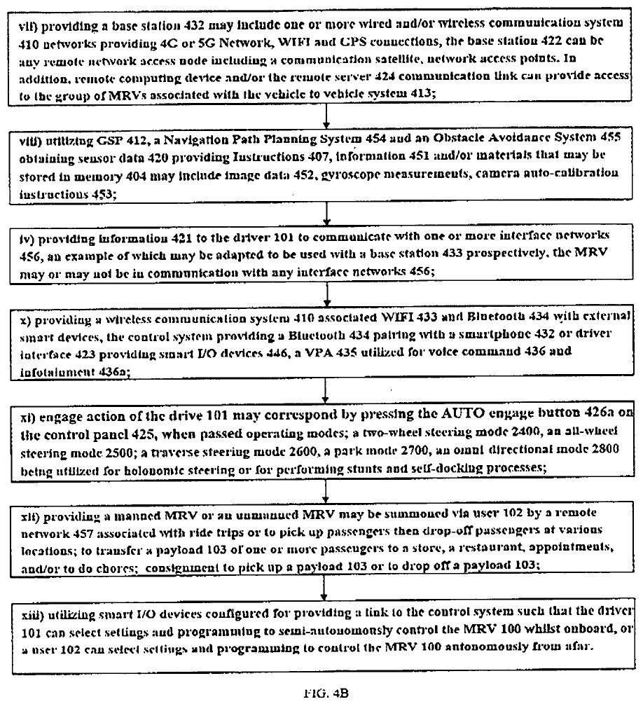

In greater detail FIG. 3A, FIG. 3B and FIG. 3C illustrate the robotic drive wheel 300 components including; a drive wheel array 301 comprising; a tire 301a, an axle 301b a hub 301c, a motor 302 which may be an electric motor or a motor configured with planetary gears, sprockets or combinations thereof, an actuated brake 303, a hanger arm 304, a housing 305, a steering controller 306, a coupling bracket 307 and wiring 308, the wiring 307 is completely contained and continuously threaded therethrough to be hidden from view. The hanger arm 304 further comprising a suspension module 309, accordingly the suspension module 309 is mounted externally on the hanger arm 304 with fasteners or contained within the hanger arm to be hidden from view as exampled in FIG. 3C, respectively the suspension module 309 is disjointedly mounted on the hanger arm to provide a rocking means for smooth transitioning when the robotic drive wheel 300 traverses over uneven terrain. Accordingly, the hanger arm is connectively coupled onto the frame's metal bracket 202 by nuts and bolts 310 as exampled herein.

As shown in FIG. 3A the frame's metal bracket 202 is configured to receive the coupling bracket 307, whereby the housing 305 and hanger arm 304 are connectively attached outwardly on the frame's metal bracket 202, the metal bracket 307 is connected thereon with nut and bolts 310 such that the robotic drive wheel 300 can be detachable for maintenance purposes or replacement.

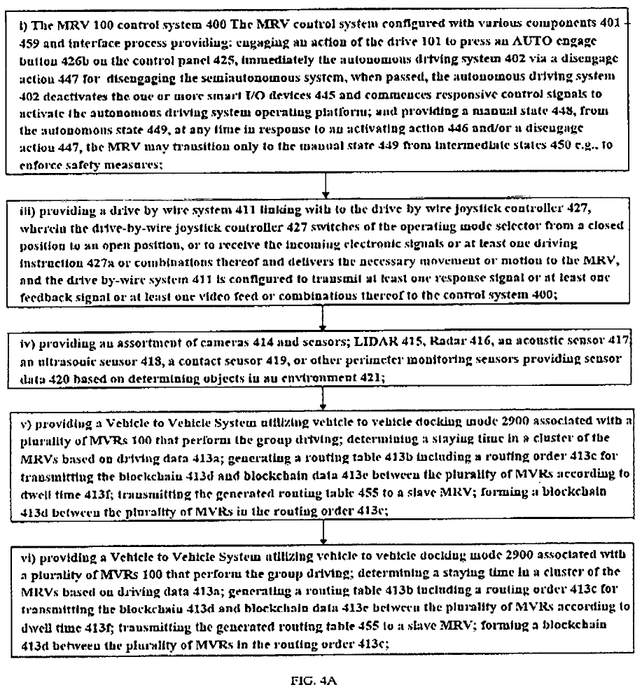

In various control elements respectively the steering controller 303 is associated with the control system 400 and with a drive bi-wire control process as explain in FIGS. 4A, 4B, accordingly the robotic drive wheel 300 may be further configured with one or more control system components.

In various aspects the control system is associated with receiving data from the gyroscope 439 set at center mass (CM) within the modular chassis 200 is utilized to keep the self-balancing vehicle 100A in a standing state.

In various aspects the control system 400 is associated with the steering controller 303, electric motor 302, actuators, encoders and an IMU 442 in accordance with driver instructions for separately controlling the rotational direction of each robotic drive wheel 300. The electric motor 302 for generating the driving force. It receives target values of an output torque, a rotational speed, etc. so that the target values are realized. The electric motor 302 control ECU also operates as a driving force generator in the negative direction through regenerative control of the electric motor to control a charged state, etc. of the battery 216 via charger 217.

The steering controller 303 comprising an actuator positioned with respect to the upper portion 204 to locally control the steering function of the robotic drive wheel 300. The steering controller 303 as shown may be used to provide functional redundancy over all steering functions. The suspension system, in FIG. 3B may by a spring-damper or other assembly requiring a fuel line 311 which are housed within and/or connected to the lower portion which may contain any electronics such as wiring and joint angle encoders needed for measuring and communicating information pertaining to the orientation of the drive wheel 301 with respect to the operating modes.

In one or aspects the steering controller 306 utilizes a steering motor 306a, an actuator 306b, encoders 306c and printed circuit board assemblies (PCBAs) 306d associated hardware which are housed in and covered by a housing assembly 305, wherein the encoders 306c configured to properly encode the position and rotational speed of a steering actuator 306a as well as to amplify steering torque from such a steering motor 306a, e.g., through the actuator 306b. As will be appreciated by those having ordinary skill in the art, such encoders 306c may include the PCBAs 306d having local task execution responsibility for the robotic drive wheel 300 within which the PCBA 303d is embedded also indicated in FIG. 3B, with instructions received from the control system 400 of FIG. 4. The various PCBAs 306d, the individual embedded controllers may include a microprocessor, tangible, non-transitory and transitory memory, transceivers, cooling plates and may utilize OEM wiring 303e, drive wheel speed sensors 306f linking OEM wiring, indicated by arrow, to the control system 400 with respect to controlling the robotic drive wheel 300.

In various elements once initiated the robotic drive wheel 300 provides three axes of rotation represented as the drive wheel pivot axis (PA), and a steering axis (SA) and accordingly each robotic drive wheel's steering controller 306 can steer the drive wheel array 300 in various directions or “omni-directionally” or “holonomic” which will achieve different steering motion scenarios.

In greater detail FIG. 4A and FIG. 4B are flowcharts of the MRV Control System 400:

i) The MRV 100 control system 400 The MRV control system configured with various components 401-459 and interface process providing: engaging an action of the drive 101 to press an AUTO engage button 426b on the control panel 425, immediately the autonomous driving system 402 via a disengage action 447 for disengaging the semiautonomous system, when passed, the autonomous driving system 402 deactivates the one or more smart I/O devices 445 and commences responsive control signals to activate the autonomous driving system operating platform; and providing a manual state 448, from the autonomous state 449, at any time in response to an activating action 446 and/or a disengage action 447, the MRV may transition only to the manual state 449 from intermediate states 450 e.g., to enforce safety measures;

ii) providing a drive by-wire system 411 linking with to the drive-by-wire joystick controller 427, wherein the drive-by-wire joystick controller 427 switches of the operating mode selector from a closed position to an open position, or to receive the incoming electronic signals or at least one driving instruction 427a or combinations thereof and delivers the necessary movement or motion to the MRV, and the drive by-wire system 411 is configured to transmit at least one response signal or at least one feedback signal or at least one video feed or combinations thereof to the control system 400;

iii) providing an assortment of cameras 414 and sensors; LIDAR 415, Radar 416, an acoustic sensor 417, an ultrasonic sensor 418, a contact sensor 419, or other perimeter monitoring sensors providing sensor data 420 based on determining objects in an environment 421;

iv) providing a Vehicle to Vehicle System utilizing vehicle to vehicle docking mode 2900 associated with a plurality of MVRs 100 that perform the group driving; determining a staying time in a cluster of the MRVs based on driving data 413a; generating a routing table 413b including a routing order 413c for transmitting the blockchain 413d and blockchain data 413e between the plurality of MVRs according to dwell time 413f; transmitting the generated routing table 455 to a slave MRV; forming a blockchain 413d between the plurality of MVRs in the routing order 413c;

v) providing a Vehicle to Vehicle System utilizing vehicle to vehicle docking mode 2900 associated with a plurality of MVRs 100 that perform the group driving; determining a staying time in a cluster of the MRVs based on driving data 413a; generating a routing table 413b including a routing order 413c for transmitting the blockchain 413d and blockchain data 413e between the plurality of MVRs according to dwell time 413f; transmitting the generated routing table 455 to a slave MRV; forming a blockchain 413d between the plurality of MVRs in the routing order 413c;

vi) providing a base station 432 may include one or more wired and/or wireless communication system 410 networks providing 4G or 5G Network, WIFI and GPS connections, the base station 422 can be any remote network access node including a communication satellite, network access points. In addition, remote computing device and/or the remote server 424 communication link can provide access to the group of MRVs associated with the vehicle to vehicle system 413;

vii) utilizing GSP 412, a Navigation Path Planning System 454 and an Obstacle Avoidance System 455 obtaining sensor data 420 providing Instructions 407, information 451 and/or materials that may be stored in memory 404 may include image data 452, gyroscope measurements, camera auto-calibration instructions 453;

viii) providing information 421 to the driver 101 to communicate with one or more interface networks 456, an example of which may be adapted to be used with a base station 433 prospectively, the MRV may or may not be in communication with any interface networks 456;

ix) providing a wireless communication system 410 associated WIFI 433 and Bluetooth 434 with external smart devices, the control system providing a Bluetooth 434 pairing with a smartphone 432 or driver interface 423 providing smart I/O devices 446, a VPA 435 utilized for voice command 436 and infotainment 436a;

x) engage action of the drive 101 may correspond by pressing the AUTO engage button 426a on the control panel 425, when passed operating modes; a two-wheel steering mode 2400, an all-wheel steering mode 2500; a traverse steering mode 2600, a park mode 2700, an omni-directional mode 2800 being utilized for holonomic steering or for performing stunts and self-docking processes;

xi) providing a manned MRV or an unmanned MRV may be summoned via user 102 by a remote network 457 associated with ride trips or to pick up passengers then drop-off passengers at various locations; to transfer a payload 103 of one or more passengers to a store, a restaurant, appointments, and/or to do chores; consignment to pick up a payload 103 or to drop off a payload 103;

xii) utilizing smart I/O devices configured for providing a link to the control system such that the driver 101 can select settings and programming to semi-autonomously control the MRV 100 whilst onboard, or a user 102 can select settings and programming to control the MRV 100 autonomously from afar.

The control system associated with one or more of the various components 459 providing interface processes 401-443 and associating with subsystems which include; semiautonomous system 401 or an autonomous driving system 402, processors 403, memory 404, algorithms 405, software 406, Instruction 407, Cloud 408, Internet of Things (IoT) 409, a Wireless Communication System 410, a Drive Bi-Wire System 411, a Global Positioning System (GPS) 412, a Vehicle to Vehicle System 413 providing an assortment of cameras 414 and sensors which may include; LIDAR 415, Radar 416, an acoustic sensor 417, an ultrasonic sensor 418, a contact sensor 419, or other perimeter monitoring sensors providing sensor data 420 based on determining objects in an environment 421, a base station 422, a driver interface 423 associated with a driver 101, a remote server 424, smart I/O devices 445 including; a control panel 425, an AUTO engage button 426a-426h, a drive-by-wire joystick controller 427, a joystick steering throttle 428, or a steering wheel 429, throttle pedal 430, brake pedal 431 disposed within a cab 1900, a smartphone 432 or tablet like devices preferably utilized by driver 101 for driver interface 423 , WIFI 433, Bluetooth 434, a virtual personal assistant (VPA) 435 associating with voice command 436, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for holonomic steering or for performing stunts, and respectively utilized when a vehicle to vehicle docking mode 2900 is engaged for a docking procedure between two MRVs.

Accordingly in various elements the control system 400 the semiautonomous system 401 selected by driver 101 and the autonomous driving system 402 selected by a driver when onboard or selected by a user who is not onboard, hence “a manned or an unmanned MRV 100”.

Accordingly, in various elements the control system 400 associating the MRV may transition from the semiautonomous system 401 to the autonomous driving system 402 or vice versa in response to an engage action of said drive 101. For example, the engage action of the drive 101 may correspond by pressing the AUTO engage button 426a on the control panel 425, when passed, the semiautonomous system 401 activating action 446 and will allow the driver 101 to utilize one or more smart I/O devices 445 to interface with the MRV. In example implementations, the transition may be carried out by toggling a mechanical joystick steering throttle 428, or use a steering wheel 429, throttle pedal 430, brake pedal 431 disposed within a cab 1900, or relay voice command to the control panel 425 via virtual assistant 435 or engage the one or more smart I/O devices. Thus, while operating in the semiautonomous state, the MRV control system operations. For example, the engage action of the drive 101 may correspond by pressing the AUTO engage button 426b on the control panel 425, immediately the autonomous driving system 402 via a disengage action 447 disengages the semiautonomous system, when passed, the autonomous driving system 402 deactivates the one or more smart I/O devices 445 and commences responsive control signals to activate the autonomous driving system operating platform.

Accordingly in various elements the autonomous driving system operating platform associating with the control system 400 one or more processors 403; and one or more memory 404 resources storing instructions that, when executed by the one or more processors, cause the MRV control system 400 to monitor a plurality of subsystem interfaces corresponding to respective operation of the MRV, wherein the respective subsystem interface is in an intermediate state 450, engage a relay of the respective driver interface 423 associated with a driver 101 or user 102 in response to the engage input, initiate a drive-by-wire controller to autonomously operate each of the plurality of MRV interfaces comprises at least a brake interface for controlling braking operations of the MRV, a steering interface for controlling steering of the MRV, and an acceleration interface for controlling acceleration of the MRV.

Accordingly in various elements the MRV may return to a manual state 448, from the autonomous state 449, at any time in response to an activating action 446 and/or a disengage action 447. For example, the disengage action 447 may be triggered by the upon detecting a driver input via the one or more manual input mechanisms and smart I/O devices, and/or detecting a failure or fault condition in one or more of the interface processes 401-443. In example implementations, the MRV may transition only to the manual state 449 from the autonomous state. This may ensure that autonomous vehicle transitions through each of the intermediate states 450 (e.g., to enforce safety measures) before the autonomous state 449 can be engaged again.

In various aspects the drive by-wire system 411 linking with to the drive-by-wire joystick controller 427, wherein the drive-by-wire joystick controller 427 switches of the operating mode selector from a closed position to an open position, or to receive the incoming electronic signals or at least one driving instruction or combinations thereof and delivers the necessary movement or motion to the MRV, and the drive by-wire system 411 is configured to transmit at least one response signal or at least one feedback signal or at least one video feed or combinations thereof to the control system 400.

Accordingly in various elements the control system 400 associating with subsystems, respectively the vehicle to vehicle system 413 in which an assortment of cameras 414 and sensors; LIDAR 415, Radar 416, an acoustic sensor 417, an ultrasonic sensor 418, a contact sensor 419, or other perimeter monitoring sensors providing sensor data 420 based on determining objects in an environment 421. For example, the control system may include several sensors 414-419 can generate respective sensor data 420. Each sensor apparatus may include one or more sensors that may capture a particular type of information about the surrounding environment 421 and objects in the environment 421, and may include a number of cameras 413 modules that can capture still images and/or videos (e.g., as sensor data 420a). Respectively the LIDAR sensor 415 can determine distance information to nearby objects (e.g., as sensor data 420b) using laser ranging techniques; and the inertial measurement unit (IMU) 442 can detect velocity, orientation, and/or gravitational information (e.g., as sensor data 420c) pertaining to the MRV 100.

Accordingly in various elements the control system 400 associating with subsystems, respectively the Vehicle to Vehicle System that links with a vehicle to vehicle docking mode 2900 associated with a plurality of MVRs 100 that perform the group driving; determining a staying time in a cluster of the MRVs based on driving data 413a; generating a routing table 413b including a routing order 413c for transmitting the blockchain 413d and blockchain data 413e between the plurality of MVRs according to dwell time 413f; transmitting the generated routing table 455 to a slave MRV; forming a blockchain 413d between the plurality of MVRs in the routing order 413c; determining whether or not the blockchain data 413e is modulated by comparing hash values of blockchains 413d formed in front and rear order MVRs 100 or other vehicles of a specific routing order 413c gathered from obtained driving data 413a.

At least one of a position at which the plurality of MVRs 100 or other vehicles leaves the cluster, an amount of battery power remaining in the MVRs 100 or other vehicle, a year of the MVRs 100 or other vehicle, a size of the MVRs 100 or other vehicle, a type of the MVRs 100 or other vehicle, or a position of the MVRs 100 or other vehicles within the cluster.

Transmitting and receiving the driving data 454 between the plurality of MRVs; encrypting the driving data of a leading vehicle with a V2X key; calculating the hash value based on the encrypted travel data and forming the block comprising the encrypted travel data and the hash value; and transmitting the block to the MVRs in a next order according to the routing order 413c.

The vehicle to vehicle system 413 wirelessly transmits a routing table and driving data to a slave MRV, receives the driving data from the slave MRV, wherein the processor determines a dwell time in a cluster of the MRVs based on the driving data of at least one MRV performs the clustering, and transmits block chain data between the plurality of MRVs according to the dwell time. Generating the routing table, forming a blockchain between the plurality of MRVs based on the routing sequence.

In various elements the control system 400 further comprising a base station 422 providing wireless communication link 433 such as a remote server 424 to one or more modular robotic vehicles. The base station 432 may include one or more wired and/or wireless communication system 410 networks providing 4G or 5G Network, WIFI and GPS connections, the base station 422 can be any remote network access node including a communication satellite, network access points. In addition, remote computing device and/or the remote server 424 communication link can provide access to the group of MRVs associated with the vehicle to vehicle system 413.

Respectively, the MRV can be configured to communicate with the remotely for exchanging various types of communications and materials including location information and map planning from the Global Positioning System (GPS) 412 provided by one or more GPS satellites.

In various embodiments, the processor 403 can be a general-purpose single or multi-chip microprocessor (e.g., an ARM processor), a special purpose microprocessor (e.g., a digital signal processor (DSP)), a microcontroller, a programmable gate array, and the like, the processor 403 may be referred to as a central processing unit (CPU). Although a processor 403 (e.g., multi-core processor) or a combination of different types of processors (e.g., ARM and DSP).

The processor 403 can be configured to implement the methods of various embodiments providing Instructions 407 can be accessed in hardware or firmware, and/or in a combination of hardware, software 406 and APPs.

The memory 404 may also be saved to Cloud 408 to store MRV data 451 related to driver settings and preferences of the MRV, and as well to store sensor data 420 gathered from; sensors and cameras (e.g., image data) exposure settings, IMU measurements, time stamps, instruction data, camera imaging data, sensor data 420.

In various elements Instructions 407, information 451 and/or materials that may be stored in memory 404 may include image data 452, gyroscope measurements, camera auto-calibration instructions 453 (including object detection commands, object tracking commands, object locations) Predictor command, timestamp detector command, calibration parameter calculation command, calibration parameter/confidence score estimator command), calibration parameter/confidence score variance threshold data, current object frame detection object position data, the previous object position data in the frame data, the calculated calibration parameter data, and the like based on the Global Positioning System 407 (GPS), and via subsystem; Navigation Path Planning System 454 and Obstacle Avoidance System 455 obtaining sensor data 420.

The memory 404 can be any electronic component capable of storing “electronic” information 451, including, for example, random access memory (RAM), read only memory (ROM), disk storage media, optical storage media, flash memory devices in RAM. The onboard memory included in the processor, the erasable programmable read only memory (EPROM), the electronic erasable programmable read only memory (EEPROM), the scratchpad, etc., including combinations thereof.

The control system 400 associated with a wireless communication system 410 utilizing smart I/O devices 445 information 421 for accommodating the driver 101 to communicate with one or more interface networks 456, an example of which may be adapted to be used with a base station 433 prospectively, the MRV may or may not be in communication with any interface networks 456 with respect to the navigation methods described herein. Accordingly said wireless communication system may also utilize a Light Fidelity (LiFi) system.

In various elements the control system 400 further associated with the base station 432 providing wireless communication link 433 associated with server 343 communicate with to one or more modular robotic vehicles traveling in groups.

The base station 432 may include one or more wired and/or wireless communication connections, the base station 433 can be any interface network 456 providing access node 457 including a communication satellite 458, network access points. In addition, remote computing device and/or communication network can provide access to the vehicle to vehicle system 413.

Respectively, the MRV can be configured to communicate with the interface network 456 for exchanging various types of location information, navigation commands 458, data queries, infotainment information 459, and the like.

The wireless communication system 410 associated WIFI 433 and Bluetooth 434 with external smart devices, the control system providing a Bluetooth 434 pairing with a smartphone 432 or other smart devices utilized for voice command 436 options, accordingly other Bluetooth paired devices may include an iPad or Tablet, Bluetooth Earphone, Google Glasses, VR headset, or handheld remote controller device with Bluetooth pairing.

The control system 400 providing WIFI 433, Bluetooth 434, a virtual personal assistant 435 associating with voice command 436 and infotainment 459 and driver interface 423.

The smartphone 434 or built-in smart I/O device smart devices 445 can be linked to the interface network 456 via WIFI provider. The smartphone 445 or other built-in smart I/O device smart devices 446 linking the drive 101 to the base station 433 allowing the driver 101 or user 102 of an unmanned MRV 100 to select a preferred operating mode.

In some embodiments of the present disclosure, a manned MRV or an unmanned MRV may be summoned via user 102 by a remote network 457 associated with Uber® or another transportation network service used to pick up passengers then drop-off passengers at various locations.

In some embodiments of the present disclosure offers a manned MRV or an unmanned MRV 100 operatively adapted for consignment to transfer a payload 103 of one or more passengers to a store, a restaurant, appointments, and/or to do chores.

In some embodiments of the present disclosure offers a manned MRV or unmanned MRV operatively adapted for consignment to pick up a payload 103 or to drop off a payload 103.

In some embodiments of the present disclosure offers a manned MRV or unmanned MRV 100 operatively adapted for consignment to places and environments liken too; outdoors, indoors, buildings, on ground, underground, submerged, up in the air, on planets or in space.

The control system 400 associated with smart I/O devices being internal or external I/O devices for accommodating the driver 101 to communicate information 427 through driver interface 423. Accordingly smart I/O devices are configured for providing a link to the control system such that the driver 101 can select settings and programming to semi-autonomously control the MRV 100 whilst onboard, or a user 102 can select settings and programming to control the MRV 100 autonomously from afar.

The body 218 accordingly being a configuration at least that of; MRV 100A-MRV 100D and MRV100E-MRV 100O exampled in FIGS. 1A, 1B, FIG. 5 through FIG. 18, respectively referred hereon as vehicle body 218A-218O connectively coupled to a modular chassis type; 200A, 200B, 2000, 2100, 2200, 2300 constructed from metal, impact-resistant plastic, lightweight aluminum, fiberglass, or conventional sheet metal, the body 218 is contoured to drape over tubular frame pieces to protect underlying electronic components and a convex shaped cavity covering each robotic drive wheel 300.

Referring now to an adaptable seating unit 228 with adjustable arms configured with right or left side holder 230 for attaching a smartphone 432 used for driver interface, the smartphone associating with WIFI 433, Bluetooth 434, a virtual assistant 435 providing voice command 436 allowing driver 101 to verbally control settings and access the IoT 409.

The driver 101 utilizes the control to access the unlocking or locking robotic drive wheels of the MRV and turning the MRV ON/OFF, the driver can control the adaptable arms and mirrors according and power on/off any head lamps 221, tail lights 222, turn signal lights 223. The adaptable chair arms contain smart I/O devices 445 including; a control panel 425, an AUTO engage button 426a-426h, a drive-by-wire joystick controller 427, a joystick steering throttle 428.

Accordingly the MRV 100A-MRV 100F may require a self-balancing component such as a gyroscope 441 assisted with an IMU 442 for providing a self-balancing process configured for maintaining an upright position of the MRV 100 during traveling and traversing on roads, and utilize the semiautonomous system 401 proving driver interface control, or utilize the autonomous driving system 402 configured for controlling the steering and speed of each robotic drive wheels disposed on right and left sides of the chassis 200A/200B, or configured for controlling the steering and speed of each robotic drive wheel 300 disposed on the right and left front portions, or configured for control ling the steering and speed and braking of each robotic drive wheel 300c disposed on the right and left rear portions, other robotic drive wheel arrangements are disposed in different framing scenarios are realized herein.

In greater detail FIG. 5 is a modular robotic vehicle can be described as a self-balancing wheelchair MRV 100B comprising modular chassis 200A configured with as a gyroscope 441 contained within a body 218B, a front portion 204 connecting to an adaptable footing platform 225 to support the drivers 101 and her/his footing placement, a bumper 219a, end portion 206 comprising a bumper 219b, a rear trunk 220b comprising upper and lower locked storage compartments, the front/rear and sides sections being configured with head lamps 221, tail lights 222, turn signal lights 223, and one or more of the following; cameras 414 and sensors 415-419 and using at least one of LIDAR 415, Radar 416; an acoustic-sensing system 417, an ultrasonic-sensing system 418, and a contact sensor 419.

The modular chassis 200 includes a seating unit 228 comprising smart I/O devices 445 including; a control panel 425, an AUTO engage button 426a-426h, a drive-by-wire joystick controller 427, a joystick steering throttle 428, a smartphone 432 or tablet like devices preferably utilized by driver 101 for driver interface 423, WIFI 433, Bluetooth 434, a virtual personal assistant (VPA) 435 associating with voice command 436, and hardware including accelerometers 439, steering actuators 440, a gyroscope accelerometer 441 and IMU 442, and a navigation subsystem 458 providing operating modes; a two-wheel steering mode 2400, the control panel 425 having a lock and key security system 425a for driver accessing use, the a joystick steering throttle 428 for controlling steering and velocity level of each robotic drive wheel 300.

Respectively the driver 101 utilizes the control panel 425 to access the unlocking or locking robotic drive wheels of the MRV 100 and turning the MRV 100 ON/OFF, the driver can control the adaptable arms and mirrors, head lamps 221, tail lights 222, turn signal lights 223, and monitor status of cameras 414 and sensors 415-419.

Respectively the control system may be associated with external smart devices providing a Bluetooth 444 link to pair with a driver's smartphone 432 or built-in smart I/O devices 445 either being utilized for voice command controlling options, as shown the smartphone 432 being connected on a coupling bracket disposed on an arm of the adaptable chair 228, accordingly the smartphone 432 or other smart input or output device being linked to a remote network or base station via WIFI 433 provider. The smartphone 432 other smart linking to the control system the smartphone 445 providing a controller means configured for selection a driver's preferred operating mode.

Respectively as shown in FIG. 5 through FIG. 18 the drive wheel arrays 301 are shown to be turned in various directions, conceivably the array of robotic drive wheels can rotate inward or outward which the following drawings indicate, however, it is to be understood that the positions of the robotic drive wheels can simultaneously rotate in a synchronized holonomic manner. Respectively the right robotic drive wheel 300 may rotated at an approximate degree between 0-306, various possibilities which may include the robotic drive wheel to turn at 45-degrees so that the hanger arm 304 of the robotic drive wheel array 301 faces outward which indicate the self-balancing vehicle MRV 100A is steering laterally to the right. Accordingly, the hanger arm 304 is facing inward would achieve the same steering to the right outcome, different rotation degrees and steering scenarios are possible.

Respectively driver 101 of the self-balancing vehicle 100A may have physical limitation to select control components with her/his hands or fingers, therefore virtual assistance technology 441 like a kind of a Siri™ or Alexa™ making it available for a driver 101 of the self-balancing vehicle 100A to control the steering and braking via driver voice control.

Referring to FIG. 6 is a modular robotic vehicle can be described as a tricycle MRV 100B comprises modular chassis 200B configured further to include front portion 204 connecting to a pultruding deck 226, a bumper 219a, end portion 206 comprising a bumper 219b, a rear trunk 220b comprising upper and lower locked storage compartments, the front/rear and sides sections being configured with head lamps 221, tail lights 222, turn signal lights 223, and one or more of the following; cameras 414 and sensors 415-419.

The pultruding deck 226 to support a driver 101 to climb on board; a spacious interior configured for footing placement of the driver 101 and having for storage; the spacious interior comprising a LED light 224. The pultruding deck 226 to support at least one dummy caster wheel 227 set underneath a lower portion 207 of the tricycle 100B to assist balance stability and for maneuvering the tricycle 100B, the caster wheel 227 providing a suspension means to transition smoothly over unlevel ground, ramps, sidewalks and street surfaces.

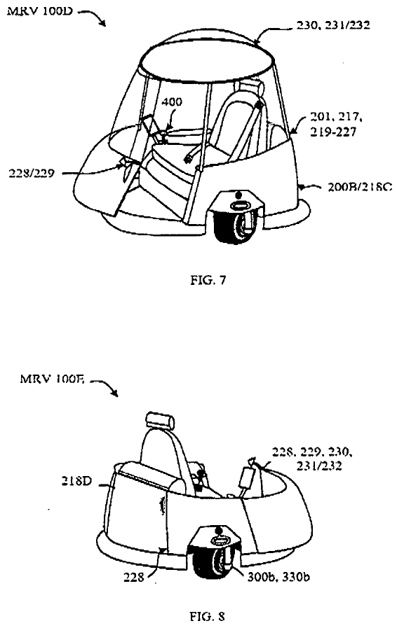

In greater detail FIG. 7 illustrates mini-car MRV 100D, wherein each are configured with modular chassis 200B and body 218D also with a pultruding deck 226 with at least one dummy wheel 227, a bumper 219a, end portion 206 comprising a front 219a and rear bumper 219b and a rear trunk 220b comprising upper and lower locked storage compartments 110 with hatch, the front/rear and sides sections being configured with head lamps 221, tail lights 222, turn signal lights 223, and portions of the modular chassis 200B and the body 218D is configured with one or more cameras and sensors 413-419.

The pultruding deck 226 to support a driver 101 to climb on board; a spacious interior configured for footing placement of the driver 101 and having for storage; the spacious interior comprising a LED light 224. The pultruding deck 226 to support at least one dummy caster wheel 227 set underneath a lower portion 207 of the tricycle MRV 100B to assist balance stability and for maneuvering the tricycle 100B, the caster wheel 227 providing a suspension means to transition smoothly over unlevel ground, ramps, sidewalks and street surface.

The body 218D are configured with a front door 228 opening for driver access and can be attached with framed brackets 229 conforming to an attachable hood 230 which is formed with plexiglass 231 and/or a cover 232 to provide shade, as shown the hood unit 230 being domed shaped, the configured to be detachable and configured with gaskets, and may be configured with an optional overhead bar or other overhead support structure, a convertible top or other hood configurations.

As shown FIG. 8 exemplifies a modular robotic vehicle which can be described as a gyro-car MRV 100E with a detached hood 230, as well as the body 218E may be configured smaller and without a hood 230, or plausibly a bumper car or a ride-on toy whereas the bumper car would not comprise a trunk or a rear hatch since bumper cars are suited for amusement park rides. The control system 400 and/or the smartphone 445 and smart I/O devices 446 can be linked to remote network or base station allowing a manned MRV 100 or a user 102 of an unmanned MRV 100 to be consigned.

In greater detail FIG. 9 is a modular robotic vehicle described as a sedan MRV 100F configured with modular chassis 2000 and body 218F, wherein the sedan MRV 100F comprises a control system 400 utilizing a variety of operating modes configured for controlling the steering of each front robotic drive wheel 300a, 300b, controlling the steering and braking of each rear robotic drive wheel 300c, 300d, respectively a control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218F is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the sedan MRV 100F.

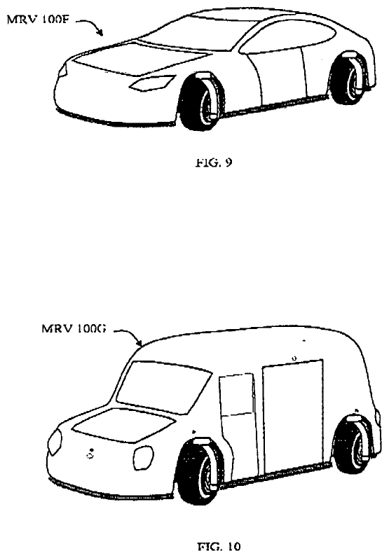

In greater detail FIG. 10 illustrates a modular robotic vehicle described as a minivan MRV 100G configured with modular chassis 2000 and body 218G, wherein the minivan MRV 100G comprises a control system 400 utilizing a variety of operating modes configured for controlling the steering of each front robotic drive wheel 300a, 300b, controlling the steering and braking of each rear robotic drive wheel 300c, 300d, respectively a control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218G is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the minivan MRV 100G.

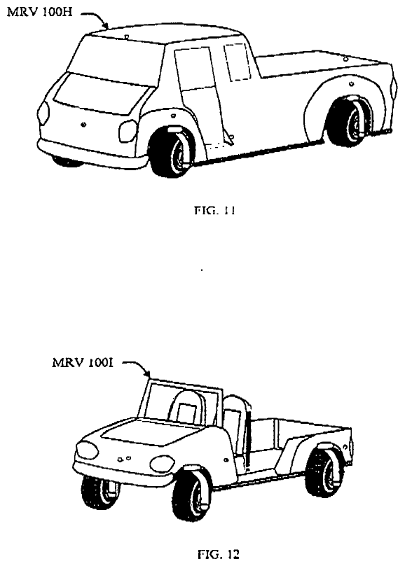

In greater detail FIG. 11 illustrates a modular robotic vehicle described as a truck MRV 100H configured modular chassis 2000 and vehicle body 218H, wherein the ATV MRV 100I configured with modular chassis 2000 and body 218H, wherein the truck MRV 100H comprises a control system 400 utilizing a variety of operating modes configured for controlling the steering of each front robotic drive wheel 300a, 300b, controlling the steering and braking of each rear robotic drive wheel 300c, 300d, respectively a control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218H is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the truck MRV 100H.

In greater detail FIG. 12 illustrates a modular robotic vehicle described as an ATV all-terrain vehicle MRV 1001 configured modular chassis 2000 and vehicle body 218I, wherein the ATV MRV 100I configured with modular chassis 2000 and body 218I, wherein the ATV MRV 100I comprises a control system 400 utilizing a variety of operating modes configured for controlling the steering of each front robotic drive wheel 300a, 300b, controlling the steering and braking of each rear robotic drive wheel 300c, 300d, respectively a control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218I is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the ATV MRV 100I.

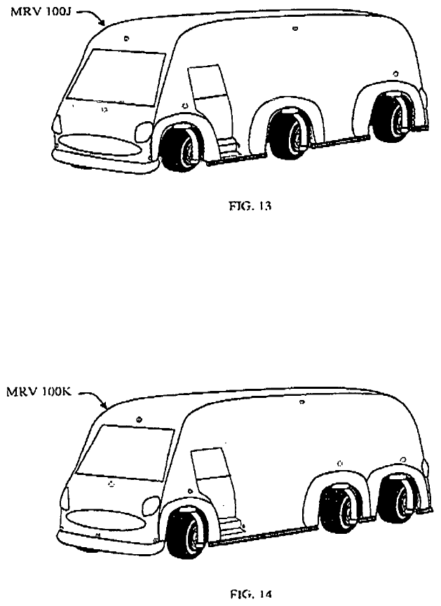

In greater detail FIG. 13 illustrates a modular robotic vehicle described as a deliver van MRV 100J configured with modular chassis 2100 and body 218J, wherein the delivery van MRV 100I comprises a control system 400 utilizing a variety of operating modes configured for controlling the steering and speed of a right front corner robotic drive wheel 300a, and a left front corner 300b, for controlling the steering and speed of and braking of a right centered side robotic drive wheel 300c and a left centered side robotic drive wheel 300d, as well as a right rear corner robotic drive wheel 300e and a left rear corner robotic drive wheel 300f. Respectively the control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218J is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 423, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system providing WIFI 433, Bluetooth 434, a virtual assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the delivery van MRV 100J.

In greater detail FIG. 14 illustrates a modular robotic vehicle described as a deliver van MRV 100K configured with modular chassis 2200 and body 218K, wherein the delivery van MRV 100I comprises a control system 400 utilizing a variety of operating modes configured for controlling the steering and speed of a right front corner robotic drive wheel 300a, and a left front corner 300b, for controlling the steering and speed of and braking of a right rear side robotic drive wheel 300c and a left rear side robotic drive wheel 300d, as well as a right rear corner robotic drive wheel 300e and a left rear corner robotic drive wheel 300f. Respectively the control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218K is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 423, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system providing WIFI 433, Bluetooth 434, a virtual assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the delivery van MRV 100K.

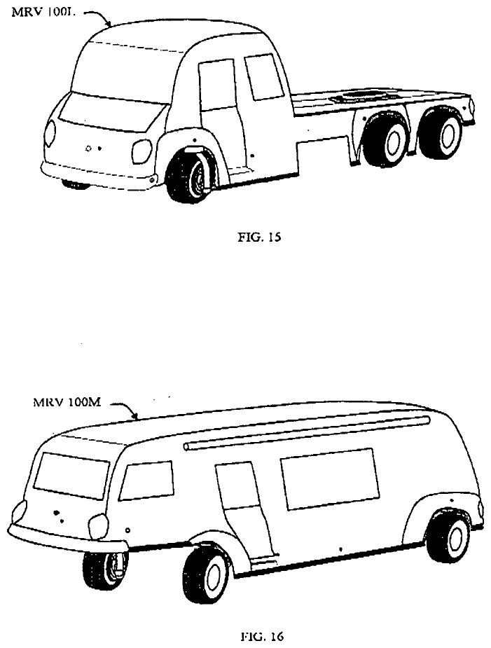

In greater detail FIG. 15 illustrates a modular robotic vehicle described as a semitruck MRV 100L configured with modular chassis 2200 and body 218L, wherein the delivery van MRV 100I comprises a control system 400 utilizing a variety of operating modes configured for controlling the steering and speed of a right front corner robotic drive wheel 300a, and a left front corner 300b, for controlling the steering and speed of and braking of a right rear side robotic drive wheel 300c and a left rear side robotic drive wheel 300d, as well as a right rear corner robotic drive wheel 300e and a left rear corner robotic drive wheel 300f. Respectively the control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218L is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 423, furthermore the cab 1900 accommodating front and rear seating units 1904a, 1904b including seat belts, a dashboard for housing a control panel 1902 components including; airbags, a control panel 1902 and a smartphone 445 attached to bracket holder 230 contained thereon, switches on the control panel when selected by the driver controls the power on/off the head lamps 221, tail lights 222.

The control system providing WIFI 433, Bluetooth 434, a virtual assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the semitruck MRV 100L.

In greater detail FIG. 16 illustrates a modular robotic vehicle described as a RV MRV 100M configured with modular chassis 2000 and body 218M, wherein the RV MRV 100M comprises a control system 400 utilizing a variety of operating modes configured for controlling the steering of each front robotic drive wheel 300a, 300b, controlling the steering and braking of each rear robotic drive wheel 300c, 300d, respectively a control system 400, when driver 101 is onboard, employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 for controlling steering and speed of each front robotic drive wheel 300a, 300b and/or controlling the steering, speed and braking of each rear robotic drive wheel 300c, 300d, as well the body 218M is configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the sedan MRV 100F.

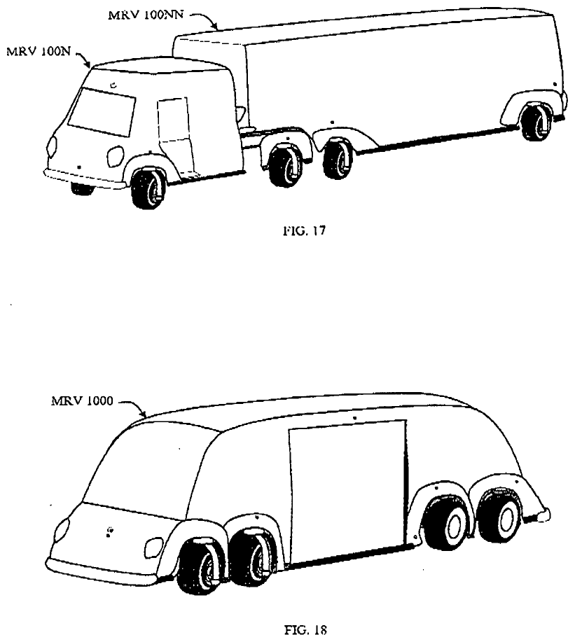

In greater detail FIG. 17 illustrates a tractor MRV 100N towing a fifth wheel MRV 100NN accordingly each providing four-wheel steering capability, which are synchronized as to maneuver about with all eight robotic drive wheels steering in various operating modes. As shown the tractor and fifth wheel array, MRV 100N/MRV 100NN, wherein each having the same chassis 2000 comprising a diverse arrangement of metal brackets, tubing or a combination thereof supporting “four” synchronized robotic drive wheel arrangements including; front robotic drive wheels 330a, 300b and two rear robotic drive wheels 300c, 300d respectively providing a two-front wheel drive arrangement and a two-rear wheel drive arrangement, and the fifth wheel MRV 100NN configured with a fifth wheel vehicle body 218NN connecting to modular chassis 1900 also comprising a diverse arrangement of metal brackets, tubing or a combination thereof supporting “four” synchronized robotic drive wheel arrangements including; front robotic drive wheels 330a, 300b and two rear robotic drive wheels 300c, 300d, respectively providing a two-front wheel drive arrangement and a two-rear wheel drive arrangement.

Respectively MRV 100N configured with modular chassis 1900 and vehicle body 218Na, and accordingly the MRV 100N comprises a control system utilizing a variety of operating modes configured for controlling the steering and braking of an array of two front robotic drive wheels 300a, 300b and two rear robotic drive wheels 300c, 300d; and respectively MRV 100NN configured with modular chassis 1900 and vehicle body 218Mb, and accordingly the MRV 100NN comprises a control system utilizing a variety of operating modes configured for controlling the steering and braking of an array of four synchronously controlled robotic drive wheels 300a, 300b, 300c, 300d.

Accordingly said tractor MRV 100N and said fifth wheel MRV 100NN combine four front robotic drive wheels 300a, 300b, 300c, 300d, and four rear robotic drive wheels 300e, 300f, 300g, 300h, respectively each robotic drive wheel is systematically controlled by said control system 400, and by various components 450 providing subsystems and operating modes, as well, an IMU 442 self-balancing process assisting an upright position of the fifth wheel during docking process and traveling traversing on roads.

Respectively both tractor MRV 100N and fifth wheel MRV 100NN further comprising a diverse arrangement of metal brackets, tubing or a combination thereof supporting a group four front synchronized robotic drive wheel arrangements and a group of four rear synchronized robotic drive wheel arrangements each group is managed by said control system 400.

Wherein a various components 401-459 associating with subsystems and operating modes are utilized for controlling steering and speed and braking of; four front robotic drive wheels 300a, 300b, 300c, 300d and utilized for controlling steering and speed and braking four rear robotic drive wheels 300e, 300f, 300g, 300h.

The MVR 100N when driver 101 is onboard, she or he employs either the semiautonomous system 401 or autonomous driving system 402 linking to a steering wheel a steering wheel 429, throttle pedal 430, brake pedal 431 disposed within a cab 1900, a smartphone 432 or tablet like devices preferably utilized by driver 101 for driver interface 423 the body 218 N and body 219NN are configured with a bumper 226a, 226b, a front trunk 227a and a rear compartment 227b comprising upper and lower locked storage compartments 110 with hatch, the front and rear sections being configured with head lamps 228, tail lights 229, turn signal lights 230, and comprising one or more sensor system may include one or more of the following; cameras 313, sensors 314-316, a LIDAR 317, Radar 318 determining objects in an environment 421. The cab 1900 components include; a steering wheel 429, throttle pedal 430, brake pedal 431, and the dashboard 1901 may be configured to house, a smartphone 432 or tablet like devices preferably utilized by driver 101 for driver interface 101a, furthermore the cab 1900 accommodating front and rear seating units 1904a, 1904b including seat belts, a dashboard for housing a control panel 1902 components including; airbags, via the control panel 1902 the driver 101 selects virtual buttons for controlling the power on/off to the head lamps 221, tail lights 222 and other devices.

The control system 400 providing WIFI 433, Bluetooth 434, a virtual personal assistant 435 associating with voice command 436 of the driver interface 423, and hardware including accelerometers 439, steering actuators 440, a gyroscope accelerometer 441 and IMU 442, and a navigation subsystem 458 providing operating modes; a two-wheel steering mode 2400, an all-wheel steering mode 2500; a traverse steering mode 2600, a park mode 2700, an omni-directional mode 2800 being utilized for performing stunts, and a vehicle to vehicle docking mode 2900. Wherein the dash board's control panel 1902 providing a lock and key security system 1905 for driver accessing use of the tractor MRV 100N and the fifth wheel MRV 100NN.

Respectively the tractor MRV 100N and fifth wheel MRV 100NN may include a remote network or base station provided for controlling the docking both tractor MRV 100N and fifth wheel MRV 100NN, and for controlling a docking process via the vehicle to vehicle docking mode 2900 whereby the docking process involving the MRV 100N to couple with another MRV 100 or other vehicles.

Respectively each tractor MRV 100N and fifth wheel MRV 100NN may utilize an environment detection system 444 providing cameras 414 and sensors 415-419 for detecting objects and identify the location of each object 448 and identify object materials 449, the objects being forklifts, humans or robots loading or unloading the MRV 100NN and/or objects in the surrounding environment 421.

Respectively both tractor MRV 100N is configured with a cab for accommodating a driver 101 and the fifth wheel is configured for payload 103 containment or is configured with a cab and cargo payload.

Respectively the tractor MRV 100N and the fifth wheel MRV 100NN are configured with a plurality of sensors, processors 401 and servers interconnected via the docking mode 2700 to assist in automatically connecting the tractor MRV 100N and the fifth wheel MRV 100NN to one another and disconnecting the tractor MRV 100N and the fifth wheel MRV 100NN from one another, more particularly each capable of driving independently when separated, and each capable of autonomously hitching to other modular robotic vehicles 100, or other vehicles.

In some embodiments, various components 450 providing subsystems and operating modes, as well, an IMU 442 provides a self-balancing process configured for maintaining an upright position of the MRV 100N/MRV 100NN during traveling and traversing on roads, whereby the linking to a steering wheel 1802 for controlling steering and speed of each front robotic drive wheel 300a, 300b; whereby the autonomous driving system 437 automatically links with the steering wheel and brakes to control steering, speed and/or braking of one or more of the robotic drive wheel; 300a, 300b, 300c, 300d.

Respectively the IMU 442 output measurement can be used to determine the height, angular rate, line speed and/or position of the MRV 100N; monitoring output by IMU 442 to extract information from one or more images captured utilizing environment 421 detection system 444 providing cameras 414 and sensors 415-419 for detecting objects and identify the location of each object 448, and identify object materials 449.

In various control elements the tractor MRV 100N and the fifth wheel MRV 100NN utilizing a vehicle to vehicle remote network 331 and/or a base station 332 providing wireless communication link 333 such as a wireless signal 333a linking with one or more modular robotic vehicles.

As exampled, the two front robotic drive wheels 300a, 300b are steering the MRV 100N “semi-truck” or “tractor” as indicated by arrows as hanger arm is facing outward, whereas, the two rear robotic drive wheels 300c, 300d are not engaged to steer the MRV 100NN as the hub is facing outward.

Accordingly the control system 400 of said tractor MRV 100N and said fifth wheel MRV 100NN linking with a remote network or base station for overseeing the vehicle to vehicle docking mode 2900 guiding each other to subsequently couple together, the process described herein.

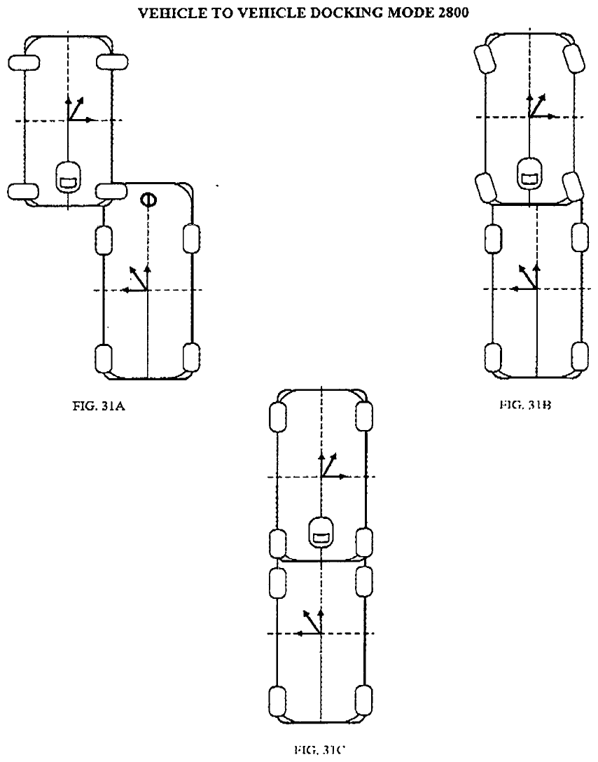

Respectively MRV 100N further comprises a skid plate and the fifth wheel MRV 100NN comprises a king pin, respectively the skid plate couples to the king pin indicated in FIGS. 31A-31C. Accordingly the fifth wheel MRV 100NN comprises a right landing gear comprising a ground contacting foot and a left landing gear comprising a ground contacting foot, the right landing gear disposed on front right corner (not shown) of the modular chassis 2100, and the left landing gear disposed on front left corner of the modular chassis 2100 as indicated by arrows each landing gear comprising a hydraulic actuator or jack ((A), B)). In various elements, the tractor MRV 100N and fifth wheel MRV 100NN are configured to provide and accomplish a docking process involving connecting and disconnecting from one another so as to couple by means of a skid plate of tractor MRV 100N latching to a kingpin of a fifth wheel MRV 100NN this mechanical process involves the tractor MRV 100N and fifth wheel to autonomously maneuvering about until the rear end of tractor MRV 100N lines up with the front end of the fifth wheel MRV 100NN, once lined up the control system of the fifth wheel MRV 100NN instructs the right and left landing gear to lower-down until the landing gear foot makes contact with the ground, not shown, according the height of the fifth wheel MRV 100NN is leveling above the tractor MRV 100N upon contact engagement between the skid plate and kingpin is competed, this process is controlled by the control system instructions, upon completion the right and left landing gear are instructed to raise back up.

In greater detail FIG. 18 illustrates a robotic vehicle which can be described as a mega-van MRV 100O configured with modular chassis 2300 and body 218O wherein the MRV 100O comprises a control system utilizing a variety of operating modes configured for controlling the steering and braking of an array of eight synchronously controlled robotic drive wheels 300a, 300b, 300c, 300d, 300e, 300f, 300g, and 300h.

Respectively the mega-van MRV 100) further comprising a diverse arrangement of metal brackets, tubing or a combination thereof supporting a group four front synchronized robotic drive wheel arrangements and a group of four rear synchronized robotic drive wheel arrangements each group is managed by said control system 400.

Wherein a various components 401-459 associating with subsystems and operating modes are utilized for controlling steering and speed and braking of; four front robotic drive wheels 300a, 300b, 300c, 300d and utilized for controlling steering and speed and braking four rear robotic drive wheels 300e, 300f, 300g, 300h, each associated with:

The mega-van MVR 100) when manned is configured with a cab accommodating seating units 1904, a dashboard 1801 for housing a control panel 1902 comprising a touch screen display switches for power on/off and control lamps, turns signals, respectively the control panel 1902 providing a keyed identifying security system 1905 for the driver 101 to unlock or lock access to the robotic drive wheels, engage power ON/OFF, control mirrors accordingly and power on/off any head lamps and control other cab amenities.

Respectively the body 218O is configured with a bumper 226a, 226b, rear/side compartments 110 with hatch for storing payload 103, the front and rear sections being configured with head lamps 228, tail lights 229, turn signal lights 230, and one or more sensor system may include one or more of the following; cameras 313, sensors 314-316, a LIDAR 317, Radar 318.

Respectively the mega-van MRV 100O may include a remote network or base station provided for controlling the docking a mega-van MRV 100O, and for controlling a docking process involving the mega-van MRV 100O to couple with another MRV 100 or other common vehicles.

Respectively the mega-van MRV 100O may utilize an autonomous driving system 402 providing cameras 413 and sensors 414-419 for detecting objects and identify the location of each object 448 and identify object materials 449, the objects being forklifts, humans or robots loading or unloading the mega-van MRV 100O and/or objects in the surrounding environment 421.

In greater detail FIG. 19 illustrates the cab 1900 and various cab components for accommodating a driver 101 and passengers, wherein a dashboard 1901 is configured with a console 1902 arranged between the two seating units 1903a, 1903b, a drive-by-wire joystick controller 427 is disposed on the console 1904, a control panel 425 connecting to the control system 400 and various components, as well the dashboard includes a steering wheel 429 to control steering of one or more robotic drive wheels 300, and comprising a floorboard configured with a speed pedal 430 for controlling velocity of each motor 302, and a brake pedal 431 for controlling the braking of the drive wheel's actuated brake 303. Wherein the control panel 425 providing a lock and key security system 1804 for driver accessing use of the MRV. Accordingly, the cab includes drive interface 438 and smart I/O devices, a smartphone 432 attached to bracket holder 230 to situate near the driver 101, respectively the control panel 1802 providing virtual buttons for selecting settings relating to driver preferences.

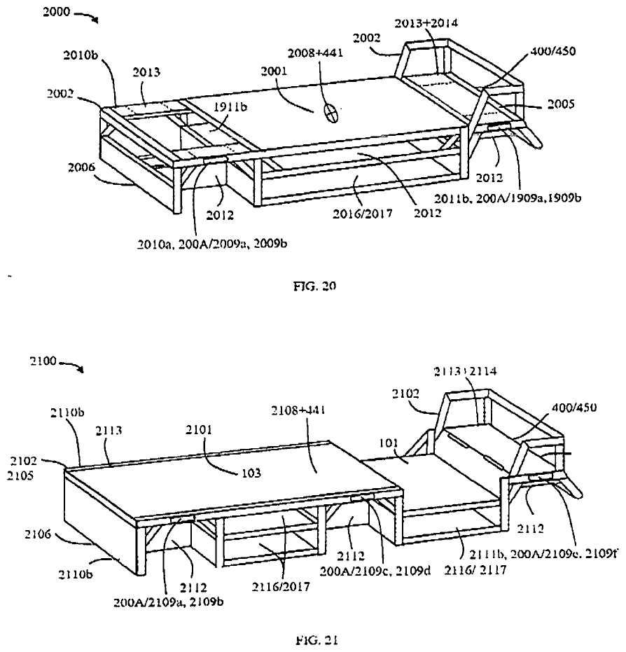

In greater detail FIG. 20 the modular chassis 2000 fully assembled for supporting payload 103, as shown a covered frame 2001 comprises a diverse arrangement of metal bracketed tubing 2002 assembled with nut and bolts 2003, as shown an upper portion 2004, a front portion 2004, an end portion 2006, a lower portion 2007, a centralized cavity 2008, frame openings 2009, a right side section 2010a and a left side section 2010b, an encasement 2011a, 2011b, a first housing 2012, fasteners 2013, an array of electrical connectors 2014, and illustrates an encasement 2011a for housing the battery 1916a and battery charger 2017a and housing 2011b for storing battery 2016b and battery charger 2017b, the chassis frame configured with heavy duty metal bracket for supporting a payload 103.

As shown a right robotic drive wheel 300a is disposed on the right side section 2010a as indicated by arrow (a) and a left robotic drive wheel 2020b is disposed on a left side section 2010b as indicated by arrow (b); respectively a battery 1915 as indicated by arrow (c) is disposed within the centralized cavity 1908, and a gyroscope 441 may be provided to assist balancing control of the modular chassis 2000, the gyroscope 441 set at center mass (CM) and housed also within the centralized cavity 401 as indicated by arrow.

In greater detail FIG. 21 the modular chassis 2100 illustrates an encasement 2111a for housing the battery 2116a and battery charger 2117a encasement, wherein the park mode 2500 examples a MRV 100 configured with a 90-degree angle accordingly all robotic drive wheels 300c, 300e and 300b, 300f are synchronized to steer sideways to the right in parallel at the same time, or the MRV 100 configured with a 270-degree angle accordingly all robotic drive wheels 300c, 300e and 300b, 300f are synchronized to steer sideways to the right in parallel at the same time.

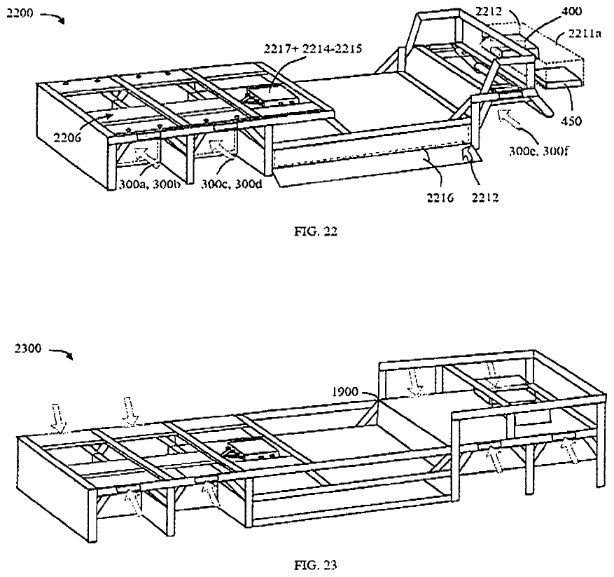

In greater detail FIG. 22 the modular chassis 2200 illustrating the frame's eight metal brackets 2202 such that eight individual robotic drive wheel 300 can be attached thereon or be detachable for maintenance purposes or replacement, for reference the shaded slots for mounting the robotic drive wheel are indicated by the white arrows, the mounting arrangement is illustrated in FIG. 3A, respectively the frame further configured to receive various metal brackets arranged on corner sections and on side sections as identified by numbering 2202a-2202i.

Accordingly in FIG. 23 the two-wheel steering mode 2300 is utilized for the driver preferring to drive the MRV 100 with tradition front wheel steering, wherein robotic drive wheels 300a, 300b are engaged to turn in the same direction at the same time, correspondingly two-wheel steering mode is achievable by all MRVS 100s, the two-wheel steering mode 2300 is associated with the other steering modes.

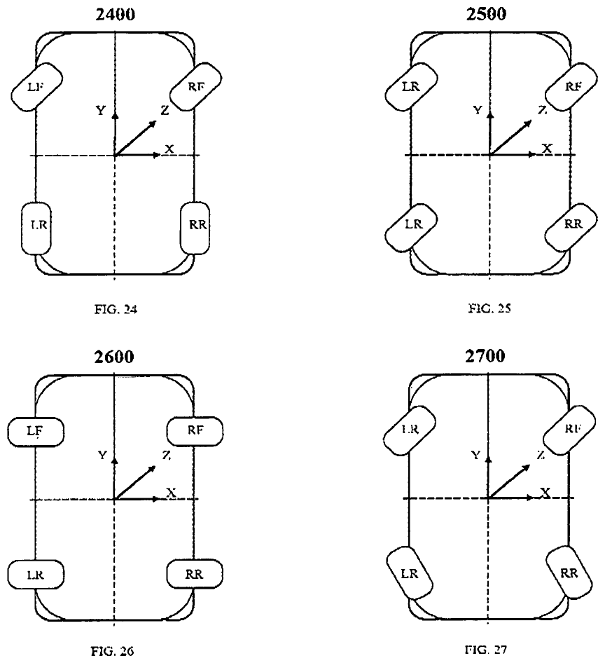

Accordingly in FIG. 24 the traverse steering mode 2400 examples a MRV 100A-MRV 100D are configured with chassis 200A/200B comprising synchronized right and left robotic drive wheels 300a, 300b configured with a steering controller set at a 45-degree angle accordingly to steer to the MRV 100A-MRV 100D to the right; or the right and left robotic drive wheels steering controller 306 is configured with a 315-degree angle accordingly to steer to the MRV 100A-MRV 100D to the left, respectively.

Accordingly in FIG. 25 the park mode 2500 examples a MRV 100 configured with a 90-degree angle accordingly all robotic drive wheels 300c, 300e and 300b, 300f are synchronized to steer sideways to the right in parallel at the same time, or the MRV 100 configured with a 270-degree angle accordingly all robotic drive wheels 300c, 300e and 300b, 300f are synchronized to steer sideways to the right in parallel at the same time.

Accordingly in FIG. 26 the traverse steering mode 2600 examples a MRV comprising right and left front corners, centered right and left sides, and rear corners coupled with robotic drive wheels 300a-300f each drive wheel is configured with a steering controller set at a 45-degree angle accordingly to steer to the MRV diagonally to the right or configured with the steering controller set at a 315-degree angle accordingly to steer to the MRV 100A-MRV 100D to the left, respectively.

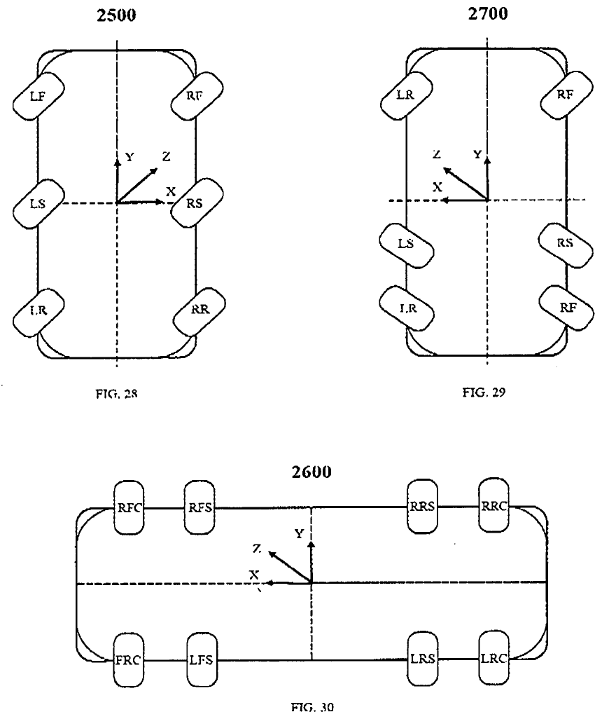

Accordingly in FIG. 27 the omni-directional mode 2700 examples the omni-directional mode 2600 respectively the front right and left robotic drive wheels 300a, and 300b steer to the right at a 45-degree angle, and at the same time, the rear right and left sides and rear corners coupled to robotic drive wheels 300c, 300d, 300e, 300f are opposed to steer to the left at 315-degrees such that all four robotic drive wheels steer to the left such that the modular robotic vehicle spins in place, respectively.

Accordingly in FIG. 28 the omni-directional mode 2700 examples the omni-directional mode 2600 respectively the front robotic drive wheels 300a, and 300b steer to the right at a 45-degree angle, and at the same time, the rear robotic drive wheels 300c and 300d are opposed to steer to the left at 315-degrees such that, the MRV spins in place, respectively.

Accordingly in FIG. 39 illustrates an eight-wheel drive arrangement, as shown the park mode 2800 examples a mega-van MRV 100 configured with a 90-degree angle accordingly all robotic drive wheels 300c, 300e and 300b, 300f are synchronized to steer sideways to the right in parallel at the same time, or the MRV 100 configured with a 270-degree angle accordingly all robotic drive wheels 300c, 300e and 300b, 300f are synchronized to steer the mega-van MRV 100O sideways to the right in parallel at the same time.

Accordingly in FIG. 30A-FIG. 30C vehicle to vehicle docking mode 2900 examples an approximate 10-degree angle laterally positioning front robotic drive wheels 300a, and 300b steer to slightly the right, and at the same time, accordingly the rear robotic drive wheels 300c, 300e and 300b, 300f are configured with an opposed 315-degree angle to steer sideways to the left, accordingly the docking process requires several steering angles to successfully self-dock or to line up in parallel with another vehicle, toad, trailer or fifth wheel to couple together, respectively each robotic drive wheel operating provided with varied degrees of axis of rotation (AOR) represented as the drive wheel pivot axis (PA), and a steering axis (SA) indicated arrows (X, Y, Z).

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected.

I claim:

1. A modular robotic vehicle comprising:
one or more modular chassis, said one or more modular chassis including a frame comprising metal brackets said metal bracket constructing: right and left side sections, or front and rear right and left corners, or a combination of front and rear right and left corners and right and left side sections;
one or more robotic drive wheels arranged on said right and left side sections, or arranged on said front and rear right and left corners, or arranged on said a combination of front and rear right and left corners and right and left side sections of said modular chassis;
wherein each of said one or more robotic drive wheels are configured with a drive wheel array including; a tire, an axle, a hub, a motor, an electric motor or a geared motor type providing fore and aft propulsion, braking, and a suspension module, an actuated brake, a hanger arm, a housing, a steering controller, a coupling bracket, and wiring contained within said hanger arm, said wiring to be completely hidden from view;
said modular chassis further comprising at least one gyroscope, IMU, accelerometers, actuators and sensors;
one or more encasements to contain one or more battery's;
one or more compartments said one or more compartments for containing various driver interface input and output devices and a control system, said control system associating with one or more of the following: a semiautonomous system, an autonomous driving system providing processors, memory, algorithms, software, Instruction, a wireless communication system, a drive bi-wire system, a vehicle to vehicle system, GPS, a navigation path planning system, an obstacle avoidance system, a base station, a remote server;
an assortment of cameras, LIDAR, Radar, an acoustic sensor, an ultrasonic sensor, a contact sensor each providing sensor data based on determining objects in an environment;
a navigation system providing operating modes; a two-wheel steering mode, an all-wheel steering mode; a traverse steering mode, a park mode, an omni-directional mode, a vehicle to vehicle docking mode providing docking procedures between two MRVs;
WIFI, Bluetooth, Cloud, internet of things (IoT);
a driver interface, smart I/O devices, a control panel, a smartphone, or said driver interface associated with a joystick throttle; or steering wheel, throttle pedal, brake pedal for driving a MRV in a semiautonomous state;
a virtual personal assistant (VPA) associating with voice command, infotainment and other driver interface processes.

2. The modular robotic vehicle of claim 1 in which said chassis further comprising a coupling means for connectively to a body, the body being one or more of the following; a robot MRV, a wheelchair MRV, a tricycle MRV, a cart MRV, a gyro-car MRV, a bumper car MRV, a ride-on toy MRV, a golf cart MRV, a sedan, a minivan, a truck, an ATV MRV, a delivery van MRV, a semitruck MRV, a recreational vehicle MRV, a tractor MRV, fifth wheel MRV, a mega-van, a bus MRV, or other vehicle body type.

3. The modular robotic vehicle (MRV) of claim 1 in which said modular chassis further comprising a gyroscope, said gyroscope for self-balancing said MRV.

4. The modular robotic vehicle of claim 1 in which said frame further comprising; one or more right sides (RS) coupled to a robotic drive wheel and one or more left sides (LS) coupled to a robotic drive wheel; a right front corner (RFC) coupled to a robotic drive wheel, a left front corner (LFC) coupled to a robotic drive wheel, and a right rear corner (RRC) coupled to a robotic drive wheel, a left rear corner (LRC) coupled to a robotic drive wheel.

5. The modular robotic vehicle of claim 1 in which said the control system further comprising a semiautonomous system associating with driver interface configured with driver input commands.

6. The modular robotic vehicle of claim 1 in which said the control system further comprising an autonomous driving system associated with a drive bi-wire process for engaging a drive bi-wire process for providing steering, propulsion stability and braking procedures.

7. The modular robotic vehicle of claims 1 and 6 in which said drive bi-wire system comprising a selection means via a bi-wire joystick controller, said bi-wire joystick controller allowing driver to engage a preferred operating mode.

8. The modular robotic vehicle of claim 1 in which said the control system further comprising for one or more processor configured for controlling a navigation process of an operating mode configured as: a two-wheel steering mode; an all-wheel steering mode; a traverse steering mode; a park mode; an omni-directional mode; a vehicle to vehicle docking mode.

9. The modular robotic vehicle of claim 1 in which said control system further comprising: an obstacle avoidance system linking with GPS, a navigation system associating with one or more of; cameras, LIDAR, Radar, an acoustic sensor, an ultrasonic sensor, a contact sensor, or other sensors associated with an autonomous driving system for detecting objects in a parameter of a MRV environment.

10. The modular robotic vehicle of claim 1 in which said control system further comprising: driver interface associated with smart I/O devices including; a smartphone or tablet like devices, a control panel with control switches.

11. The modular robotic vehicle of claim 1 in which said control system further comprising: driver interface associated with a bi-wire joystick controller, once operating modes are selected said control system actively engages navigation processes to commence driving said MRV either manned or unmanned.

12. The modular robotic vehicle of claim 1 in which said operating mode comprising:
a two-wheel steering mode is utilized for the driver preferring to drive the MRV with tradition front wheel steering, wherein right and left robotic drive wheels are engaged to turn in the same direction at the same time, correspondingly up to an approximate 90-degrees or an approximate 270-degrees;
a traverse steering mode configured to steer all front and rear robotic drive wheels to the right at a 45-degree angle at the same time to travel diagonally to the right, or configured to steer all front and rear robotic drive wheels to the left at a 315-degree angle at the same time to travel diagonally to the left, respectively;
a park mode is configured to steer one said one or more robotic drive wheels to the right at a 90-degree angle or configured to steer one said one or more robotic drive wheels to the left at a 270-degree angle in parallel;
an omni-directional mode configured to steer one said one or more robotic drive wheels to the right at an approximate 45-degree angle, and at the same time, steer said one or more robotic drive wheels to the left at an approximate 315-degrees such that, the modular robotic vehicle spins in place, respectively;
a vehicle to vehicle docking mode providing an approximate 10-degree steering angle for laterally positioning front positioned robotic drive wheels to steer to slightly the right, and at the same time, accordingly the rear positioned robotic drive wheels are configured with an approximate or opposed 315-degree angle to steer sideways to the left, accordingly the docking process requires several steering angles to successfully self-dock or to line up in parallel with another vehicle, toad, trailer or fifth wheel to couple together, respectively each robotic drive wheel operating provided with varied degrees of axis of rotation (AOR) represented as robotic drive wheel pivot axis (PA), and steering axis (SA) indicated arrows (X, Y, Z).

13. The modular robotic vehicle of claim 1 in which said wireless communication system further comprising WIFI providing the internet of thing (IoT), software and software updating, downloading APPs, and accessing associated driver interface protocols; and Bluetooth linking the driver commands to the MRV via preferred smart I/O devices.

14. The modular robotic vehicle of claim 1 in which said control system further comprising a virtual personal assistant to carry out voice command of a driver, said a virtual personal assistant paired with said control system and paired with smart I/O devices, which may include; steering motor, brakes, and other internal devices, and external device like control panels, speakers, and smart cab components.

15. The modular robotic vehicle of claim 1 in which said vehicle to vehicle system is further configured to:
detect a docking maneuver of the modular robotic vehicle;
detect a docking maneuver of an additional vehicle;
detect maneuvers modular robotic vehicles working a group;
determining at least one of a position at which the plurality of MVRs or other vehicles leaves a cluster, an amount of battery power remaining in the MVRs 100 or other vehicle, a year of the MVRs or other vehicle, a size of the MVRs or other vehicle, a type of the MVRs 100 or other vehicle, or a position of the MVRs or other vehicles within the cluster;
transmitting and receiving the driving data between the plurality of MRVs; encrypting the driving data of a leading vehicle with a V2X key; calculating the hash value based on the encrypted travel data and forming the block comprising the encrypted travel data and the hash value; and transmitting the block to the MVRs in a next order according to the routing order;
wirelessly transmitting a routing table and driving data to a slave MRV;
receives the driving data from the slave MRV;
wherein a processor determines a dwell time in a cluster of the MRVs based on the driving data of at least one MRV performs the clustering, and transmits block chain data between the plurality of MRVs according to the dwell time;
generating the routing table, forming a blockchain between the plurality of MRVs based on the routing sequence.

16. A modular robotic vehicle comprising:
a modular chassis configured with frame brackets supporting a body and an array of robotic drive wheels which are systematically controlled by a control system of said modular robotic vehicle (humanoid MRV);
said body further comprising a control panel providing a touch screen display with virtual switches for a user to select settings associating with a keyed identifying security system allowing said user to unlock or lock access to said array of robotic drive wheels and/or to access various control system components;
said control panel is integrated with a user interface associated with smart I/O devices which may include; a smartphone, an iPad, PC, or other smart I/O device providing paired communication;
wherein said humanoid MRV linking with said user's smartphone provided with Bluetooth pairing such that said user can communicate with said humanoid MRV;
said control panel is integrated with a user interface associated to select her or his preferred settings to access smartphone speakers and microphone, and to activate a virtual personal assistant, respectively said virtual personal assistant for providing user voice command;
said user interface and virtual personal assistant associated with navigation programming, to update software;
said humanoid MRV configured with a control system linking battery power to said array of robotic drive wheels and to various subsystem components;
said body configured with one or more compartments providing with hatches; said one or more compartments for housing battery(s), various subsystem components, a payload, wherein said hatches configured for accessing said various subsystem components or said payload.

17. The modular robotic vehicle of claim 16 in which said body further comprising:
a portion configured with or without a head, said head configured with an augmented head comprising computer-generated interactive facial components, or an augmented head with interactive LED lighting components;
said augmented head comprising computer-generated interactive facial component being human like or animal like;
said augmented head with interactive LED lighting components being futuristic looking;
a truck portion configured with one or more robotic arms; said one or more robotic arms configured with robotic hands, grippers, suction devices, or other handling implements;
a base portion, said base portion connectively couple with a modular chassis;
a disjointed waist, said disjointed waist disposed between said trunk portion and said base portion, said disjointed waist configured to rotate said trunk portion at an approximate angle degree opposed to said base portion, said disjointed waist providing an approximate one-degree to 359-degree rotation or spinning at zero-degree rotation.

18. The modular robotic vehicle of claim 16 in which said modular chassis further comprising:
a frame configured with a coupling arrangement of fasteners, nuts and bolts for connectively coupling said modular chassis to a base portion of a body of said humanoid MRV;
said modular chassis including frame assemblies configured with side sections, corners, or a combination of corners and side sections;
one or more robotic drive wheels arranged on said side sections, said corners, or said combination of said corners and said side sections;
wherein the frame assemblies including; metal brackets assembled with nut and bolts, as shown an upper portion, a front portion, an end portion, a lower portion, a centralized cavity, frame openings, a right side section and a left side section, an encasement, a first housing, fasteners, an array of wiring with electrical connectors; respectively a battery and charger is disposed within said centralized cavity, and a gyroscope is provided to assist with balance of the humanoid MRV;
wherein said gyroscope accelerometer set at center mass (CM) and housed also within said centralized cavity, and utilizing one or more of; an IMU, and autonomous driving system cameras and sensors;
wherein said one or more robotic drive wheels including; a drive wheel array comprising; a tire, an axle, a hub, a motor which may be an electric motor or a motor configured with planetary gears, sprockets or combinations thereof, an actuated brake, a hanger arm, a housing, a steering controller, a coupling bracket and wiring, wherein said wiring is completely contained and continuously threaded therethrough said hanger arm and said housing to be hidden from view;
wherein said hanger arm further comprising a suspension module mounted on the hanger arm with fasteners, or said a suspension module is contained within said hanger arm to be hidden from view; respectively said suspension module is disjointed for said robotic drive wheel to smoothly travel on uneven terrain, respectively;
wherein said suspension module may include a spring-damper or an assembly requiring a fuel line may situate within said hanger arm to access a lower portion of said hanger arm;
wherein said hanger arm is connectively coupled onto the frame by an arrangement of fasteners, nuts and bolts;
wherein said metal bracket is configured to receive said coupling bracket of drive wheel array, said coupling bracket is connectively attached outwardly such that the hanger arm is able to rotate within said cavity and not bang against the frame; respectively said coupling bracket is connected with nut and bolts such that the robotic drive wheel is detachable for maintenance purposes or replacement.

19. The modular robotic vehicle of claim 16 in which said drive wheel array further comprising:
a steering controller, an electric motor, an actuator, an encoder and an IMU in accordance with driver instructions for separately controlling the rotational direction of a drive wheel;
said steering controller and electric motor configured with internal wiring connections;
said electric motor providing a driving force generator receiving target values of an output torque upon a rotational speed so that the target values are realized, wherein said driving force generator in a negative direction through regenerative control of said electric motor via control system is to control a charged state of said battery;
said steering controller comprising an actuator positioned with respect to the upper portion to locally control the steering function of the robotic drive wheel;
said steering controller may provide functional redundancy over all steering functions;
said steering controller utilizing encoders and printed circuit board assemblies (PCBAs) associated hardware, which are housed in and covered by a housing assembly;
wherein said encoder configured to properly encode a position and rotational speed of a steering actuator as well as to amplify steering torque from such a steering motor through the actuator of a steering controller of the one or more robotic drive wheels.

20. A modular robotic vehicle comprising:
a tractor MRV and a fifth wheel MRV arrangement;
said tractor MRV comprising a modular chassis, said modular chassis configured with frame brackets supporting an array of robotic drive wheels which are systematically controlled by a control system, and said fifth wheel MRV comprising a modular chassis, said modular chassis configured with frame brackets supporting an array of robotic drive wheels which are systematically controlled by a control system; said control system of said tractor MRV and said control system of said fifth wheel MRV are wirelessly linked such that both tractor MRV and fifth wheel MVR collaborate to connect to one another, thus becoming a tractor/fifth wheel MRV configured with an eight-wheel drive arrangement;
each control system of said tractor MRV and said fifth wheel MRV systematically collaborate to control steering and speed, braking and stability of each robotic drive wheel configured in said eight-wheel drive arrangement;
said tractor MVR being manned or unmanned;
each said tractor MRV and said fifth wheel MRV configured with a compartment with hatch for storing one or more consigned payloads;
said tractor MRV when manned is configured with a cab and a compartment, said cab providing seating units, a dashboard for housing a control panel comprising a touch screen display switches for power on/off and control lamps, turns signals, respectively the control panel providing a keyed identifying security system for the driver to unlock or lock access to the robotic drive wheels, engage power ON/OFF, control mirrors accordingly and power on/off any head lamps and control other cab amenities; wherein said control panel correspondingly linking with said control system of said fifth wheel MRV; said control panel is integrated with user interface associated with smart I/O devices for accommodating the driver to communicate through user interface; wherein driver's smartphone or iPad provides a Bluetooth pairing link to the various control system components such that driver can communicate with said tractor MRV to select her or his preferred settings, navigation programming, to update software, to access smartphone speakers and microphone link to a virtual personal assistant accordingly for providing driver voice commands;
said tractor when unmanned configured with a control system linking battery power to various MRV subsystem components and to a compartment providing one or more hatches; said compartment for housing a payload, said hatched configured for accessing said payload;
said one or more consigned payloads are housed within said tractor's container or one or more consigned payloads are housed within said fifth wheel's container;
each said tractor MRV and said fifth wheel MRV configured with head lamps, tail lights, turn signal lights, one or more sensor system which may include one or more of the following; cameras, sensors associated with an autonomous driving system, LIDAR, Radar and other related sensor devices;
each said tractor MRV and said fifth wheel MRV configured with cameras and sensors utilized for detecting objects and identify the location of each object and identify object materials, the objects being forklifts, humans or robot MRV and/or other robot types loading or unloading said fifth wheel MRV and/or objects in the surrounding environment;
said tractor MRV driver utilizing driver interface associated with one or more of the following components and I/O devices: a control panel allowing a driver via said driver interface to select one or more of the following operating modes; a two-wheel steering mode, a traverse steering mode; a park mode; an omni-directional steering mode, and a docking mode, a vehicle to vehicle mode;
each said tractor MRV and said fifth wheel MRV may utilize one or more the of following control system and subsystem processes: utilizing wireless communication link such as a wireless signal linking to a base station, each providing instructions to engage one or more of said operating modes;
each said tractor MRV and said fifth wheel MRV may utilize a remote network or base station provided for controlling the docking said tractor MRV and said fifth wheel MRV, and for controlling a docking process via docking mode process involving said MRV to couple with another MRV or other vehicle types;
each said tractor MRV and said fifth wheel MRV configured with a plurality of sensors, processors and servers interconnected via the docking mode to assist in automatically connecting the tractor MRV and the fifth wheel MRV to one another and disconnecting the tractor MRV and the fifth wheel MRV from one another, more particularly each capable of driving independently when separated, and each capable of autonomously hitching to other modular robotic vehicles, or other vehicle types.
